(19) United States
(12) Patent Application Publication
(10) Pub. No.: US 2017/0015055 A1
(43) Pub. Date: Jan. 19, 2017

(54) METHOD FOR BONDING FIBER-REINFORCED PLASTIC COMPONENTS HAVING A THERMOSETTING MATRIX

(71) Applicant: LEICHTBAU-ZENTRUM SACHSEN GMBH, Dresden (DE)

(72) Inventors: Werner HUFENBACH, Dresden (DE); Martin LEPPER, Dresden (DE); Jöm KIELE, Dresden (DE); Stefan KIPFELSBERGER, Dresden (DE); Jens WERNER, Coswig (DE)

(73) Assignee: Leichtbau-Zentrum Sachsen GmbH, Dresden (DE)

(21) Appl. No.: 15/124,010

(22) PCT Filed: Mar. 6, 2015
(86) PCT No.: PCT/EP2015/054734

§ 371 Date: Sep. 6, 2016

(30) Foreign Application Priority Data
Mar. 7, 2014 (DE) 10 2014 204 255.0

(51) Int. Cl. B29C 65/70; B29C 35/16; B29C 70/48; B29C 65/00; B29C 70/46

(52) U.S. Cl. CPC B29C 65/70; B29C 66/131; B29C 66/12221; B29C 66/71; B29C 66/7212; B29C 66/72141; B29C 66/73754; B29C 66/73941; B29C 66/91411; B29C 66/91945; B29C 70/46; B29C 70/48; B29C 35/16; B29C 2035/1608; B29K 2063/00

(57) ABSTRACT

The present invention relates to a method for producing thermosetting components from two or more semifinished composite-material products with textile fibre reinforcement and matrix material, wherein the semifinished composite-material products are fully consolidated, with the exception of local regions, and are brought into contact at the partially consolidated (gelled) regions (201, 211, 221, 241) such that the matrix material of the partially consolidated regions (201, 211, 221, 241) bonds and the regions joined together in this way are subsequently fully consolidated. Furthermore, a device which is suitable for producing the semifinished composite-material products is disclosed.

The present invention relates to a method bonding fiber-reinforced plastic component parts together, by contacting partially consolidated (gelled) local regions of the component parts with each other or with other regions of the component parts, and hardening said regions. The invention also relates to devices which are suitable for fabricating the fiber-reinforced plastic component parts having partially consolidated (gelled) local regions of the component parts, and for processing said component parts.

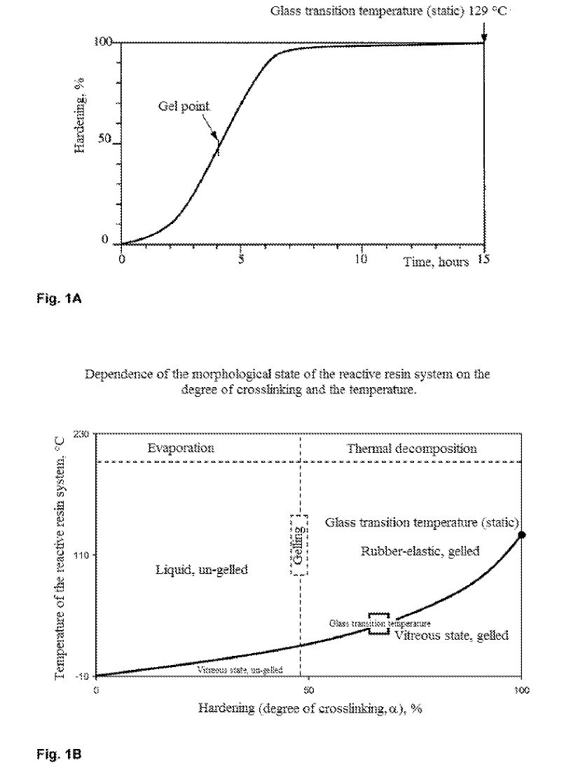

The term “consolidation” will be understood to mean the process of hardening (or crosslinking) of the reactive resin system which system is employed as a matrix material in the system comprised of a fiber reinforcement means and a matrix means, in the fiber-reinforced composite material. The process of hardening (consolidation) is in particular time-dependent and temperature-dependent, and is specific for each reactive resin system. Information about the course of the crosslinking (the course of the hardening or consolidation) is available from the manufacturer of the resin system. As consolidation progresses, reactants comprised of the original monomers or prepolymers are increasingly converted, and thereby the degree of crosslinking of the polymer network is increased (see FIG. 1). The un-consolidated state is characterized by a degree of crosslinking near 0% (preferably <2%), and the completely consolidated state is characterized by a degree of crosslinking near 100% (preferably >98%). In arriving at the consolidated state, a reactive resin system passes through a partially consolidated state—the so-called gelled state. This state is characterized by the fact that the reactive resin has solid properties and is no longer flowable when heated.

Fiber-reinforced plastic composite component parts on a thermosetting basis are fabricated, according to the prior art, e.g. by means of RTM technology (resin transfer molding), VARI methods (vacuum-assisted resin infusion), or VAP processes (vacuum-assisted process), in dry systems, or by means of pressing, autoclaving, etc. in partially consolidated systems (e.g. prepregs).

According to the prior art, thermosetting component parts are usually bonded together by adhesive bonding or by mechanical fastening means such as screws, rivets, clamps, or form-interlocking joining mans (snap means).

A problem with adhesive bonding is, among other things, that the adhesive material employed in conjunction with thermosetting component parts is unstable with respect to other materials other than the thermosetting matrix, under certain circumstances. The bonded component parts are then unsuitable for many desired applications. Other adhesive materials are less durable over time or are less resistant to UV irradiation (e.g. sunlight) than the thermosetting matrix, so that the adhesive bonding reduces the service life of the component part. In addition, the mechanical parameters of an adhesive bond are often inferior to those of the fiber-reinforced material of the components, for one reason because the adhesive bond is effective only near the surface. Mechanical fastening means such as screws or clamps are costly to install, and they have the potential to loosen, which makes it necessary to subsequently monitor the fastening or at least to keep the fastening locations accessible for possible maintenance activities. Further, when subjected to loads, these fastening means are subject to locally very large forces, which can lead to failure in the materials at the transition loci at the mechanical fastenings.

Other methods in the prior art, e.g. in DE 10 2011 108219 A1, involve re-forming of, and injection molding around, a pre-consolidated composite component part in an injection molding apparatus. Then the composite component part is subjected to hardening.

Similarly, in the prior art, in WO 2010/31710 A1, involves inserting a textile into a molding tool and impregnating it with resin. Then the textile is at least partially hardened. In a subsequent step, one of the two mold halves is replaced, with the textile remaining in the other half. Then additional plastic material is applied by injection molding.

According to this prior art method, invariably a fiber-reinforced component part has additional plastic applied to it by injection molding. This additional plastic does not itself have reinforcement comprised of endless fibers. It is a characteristic of this method that it does not allow fabrication of complex forms, e.g. having hollow spaces.

Accordingly, an underlying problem of the present invention was to devise a method for bonding semifinished composite-material products, particularly comprised of thermosetting materials, which avoids the described drawbacks under the prior art, and which enables bonding of two or more fiber-reinforced thermosetting semifinished products to form a complex molded overall component part.

According to the invention, this problem is solved by the method according to claim 1. Additional advantageous methods are set forth in the dependent claims therefrom. Further claimed matter of the present invention consists of a device for fabricating the component parts employed in the inventive method. This device is described in claim 8. Preferred embodiments of this device are set forth in the dependent claims therefrom.

According to the invention, the problem stated is solved in that fiber-reinforced thermosetting semifinished composite-material products (referred to as “the semifinished products”) are fabricated which are fully consolidated, with the exception of local regions, or else are entirely in a partially consolidated, gelled state. In the said local regions, or in the entire component part, the consolidation process (crosslinking reaction) is interrupted at a given degree of crosslinking, in order to bring about the partially consolidated gelled state of the resin system. Particularly preferably, this results in a vitreous gelled or rubber-elastic gelled morphological state (according to FIG. 1b). In another step of the method, two or more semifinished composite-material products are brought into contact at the local partially consolidated, gelled regions and the said regions are joined together, further consolidated, and then (optionally) the said regions or the entire component part is/are completely consolidated. The material used as a matrix material is preferably a thermally consolidatable matrix material. The matrix materials of all of the semifinished composite-material products which participate in the bonding are identical or at least compatible, so that one achieves a cohesive bonding of the matrix material between the two semifinished products in the previously partially consolidated local regions. The matrix material is preferably comprised of a reactive resin system such as polyester, epoxy resin, polyurethane resin, or phenolic resin.

The inventive method for producing thermosetting component parts from a plurality of semifinished composite-material products (or a plurality of regions of a semifinished composite-material product), each having a textile fiber reinforcement means and a matrix material, is thus characterized in that the semifinished composite-material products are completely consolidated with the exception of local regions, or are entirely partially consolidated, and two or more semifinished composite-material products are brought into contact, preferably into surface contact (generally flat surface contact), such that the matrix materials of the local regions become bonded together, and the regions thus brought together subsequently become completely consolidated. Preferably, the further consolidation of the bonding locations results in a common polymer network over the joining locations of the participating semifinished composite-material products or beyond.

According to a preferred version of the method, the sections of the textile reinforcing material provided for the partially consolidated, gelled local regions are later impregnated with matrix material, in the manner of the impregnation of the other textile reinforcing material. This procedure can improve the control over the state of crosslinking in the partially consolidated regions.

According to a preferred version of the method, the sections of the textile reinforcing material provided for the partially consolidated, gelled local regions are hardened by a different course of the temperature than the other textile reinforcing material undergoes. This procedure can advantageously improve the control over the state of crosslinking in the partially consolidated regions.

According to another preferred version of the method, the sections of the textile reinforcing material provided for the partially consolidated, gelled local regions are hardened under a different course of pressure than the other textile reinforcing material undergoes. This procedure can advantageously improve the control over the state of crosslinking in the partially consolidated regions.

According to yet another preferred version of the method, the sections of the textile reinforcing material provided for the partially consolidated, gelled local regions are provided with a different fiber count (per unit volume), fiber orientation, and/or type of fibers, than the other reinforcing material. This procedure can improve the control over the state of crosslinking in the partially consolidated regions.

According to still another preferred embodiment, inserts are provided which are completely enclosed in the semifinished composite-material products or in the final component part. According to a preferred embodiment, the inserts are inserted in the component part by applying them to a semifinished composite-material product, followed by covering with a second semifinished composite-material product, such that the inserts are surrounded partially or completely by partially consolidated, gelled local regions which are then bonded together such as to completely or at least partially enclose the inserts. In this manner, one can create hollow spaces in the nature of pockets, which are preferably closed or are open on one side, disposed between the semifinished composite-material products, preferably to accommodate inserts.

According to a further preferred embodiment, the inserts are applied to a semifinished composite-material product, such that the inserts come into contact with partially consolidated, gelled local regions. Subsequent consolidation results in adhesive bonding of the inserts and the semifinished composite-material products.

According to a first preferred embodiment, the partially consolidated, gelled local regions have greater area, preferably substantially greater area, than the consolidated regions of the semifinished composite-material products. According to a second preferred embodiment, this relationship is reversed. The surface proportions and configurations of the partially consolidated, gelled local regions can be adjusted in practically any manner. Preferred configurations are round, oval, polygonal, or stripe-like. Particularly preferably, the local regions near the edges of two (or more) semifinished composite-material products, which are to be bonded together, are in the form of a row of distinct regions or a series of stripes.

According to the invention, it is advantageous if curved or otherwise formed sections are consolidated prior to the gelification, for the sake maintenance of their shape during temporary storage prior to the final processing. Because the semifinished composite-material products are preferably provided with thermally hardening matrix material, storage is preferably carried out with the hardening state of the resin system being in the vitreous state. The necessary temperatures depend on the matrix material selected, and are known from the prior art and/or from manufacturer-supplied data, or they may be determined by simple measurements by means of DSC (differential scanning calorimetry), DMA (dynamic mechanical analysis), and rheometry, in accordance with the prior art. It is also necessary to maintain the temperature if intermediate steps such as processing (e.g. printing or cutting), or transferring (shipping or storage), are to be carried out between fabrication of the semifinished product and the final step. Some resin systems according to the prior art have a vitreous state at room temperature, and/or can be stored for a limited time at room temperature without experiencing further consolidation.

According to a preferred refinement of the inventive method, after the partially consolidated, gelled local regions of two or more semifinished products are brought together for joining, these regions are stitched together. This step advantageously strengthens the bonding of the semifinished products. The term “stitching” in this context is understood to mean any and all methods of fastening of textiles in accordance with German Industrial Standard DIN 61400. It involves passing of one or more fibers (threads) through the stitched items (through the partially consolidated, gelled local regions of two or more semifinished products, and in particular through the fiber reinforcement means in these regions), wherewith the threads are mutually intertwined or are engaged with the stitched items. The threads used for the stitching may be identical to or different from the reinforcing fiber material.

Also, according to a preferred refinement, the textile reinforcing means of the partially consolidated, gelled local regions are joined by clamping, stapling, or similar techniques. Preferably, but not mandatorily, the clamping or joining element is comprised of the same material as the textile reinforcing means of the component parts which are to be joined, or at least is comprised of a compatible material.

The inventive method allows one to advantageously eliminate the use of additional materials (e.g. adhesive materials). Further, mechanical fastening elements can be eliminated. The component part comprised of the semifinished composite-material products has a uniform matrix material structure. The semifinished composite-material products are cohesively bonded together. The mechanical properties are significantly improved compared to prior art methods.

The device for fabricating semifinished composite-material products with un-consolidated or partially consolidated local regions corresponds to RTM devices according to the prior art. These comprise a tool with two or more molding parts, between which the reinforcing fiber textile is inserted, is pressed into the desired form, and is impregnated with the matrix material. It is also possible to insert a reinforcing fiber textile which has already been impregnated. Then the matrix material is hardened, by heating the mold. For this purpose, the mold has integrated heating elements, which are based on, e.g., electrical resistance heating or electrical induction, or which function by passing a heat carrier medium through passages. Here solutions according to the prior art are preferred. The inventive device may comprise integrated cooling elements, in addition to the described integrated heating elements. These cooling elements are disposed in the molding tool(s) so as to cool the locations of the textile which has been impregnated with matrix material, at which locations the un-consolidated or partially consolidated regions of the semifinished composite-material products are to be maintained. Since the matrix material is thermally hardened (thermally hardenable), these regions remain un-consolidated or partially consolidated, as a result of the cooling. The cooling can be employed as soon as the start of the impregnation of the textile with matrix material, or later, so that, depending on the need, completely un-consolidated or partially consolidated local regions can be generated. The degree of consolidation can also be controlled by regulating the temperature. Electrically operated elements such as Peltier elements can also be integrated into the molding elements. It is also possible to employ cooling liquids (cooling fluids) in suitable channels in the molding elements. Cooling can also be achieved by appropriate geometric configuration of the molding tool, i.e. taking advantage of the heat capacity, without providing additional cooling means. It is also possible to employ cooled supplemental elements, e.g. cooled strips, which are applied to or attached to the molding tool from the outside. Preferably, these are applied after a prescribed time, which time depends on the resin system.

A suitable process temperature, preferably between 60 and 300° C., particularly preferably between 80 and 250° C., is selected (depending on the resin system, the desired cycle times, and the presence of inserts), which temperature is attained via the heating elements, so as to consolidate the semifinished composite-material products with a wall thickness which is preferably in the range 0.1-20 mm, particularly preferably 0.5-2 mm. Preferably the internal pressure in the molding tools is 1-50 bar, particularly preferably 1-25 bar. The local consolidation process is retarded by the following techniques:
The temperature is locally reduced (according to the crosslinking diagram) via the cooling elements; and/or
In RTM tools, via a suitable sprue arrangement, so that the desired component part regions are not infiltrated until a later time.

After the component part is removed from the mold, it is stored, preferably at room temperature, or in a cooled or frozen state (depending on the resin system and the crosslinking reaction), in order to interrupt the consolidation process.

According to a preferred embodiment, the device may be supplied with resin at a later time, by a suitable arrangement of inlets and outlets, and/or by suitable positioning of the vacuum supply of the regions which have not been consolidated or which have been only partially consolidated, and by controlling the flow path of the matrix material during the infiltration.

The partially consolidated, gelled local regions of the semifinished composite-material products are bonded together by bringing said regions of two (or more) semifinished products together, followed by consolidation. The consolidation can be accomplished by various means. Preferably, the joining is accomplished by pre-stressing the semifinished products and placing them in a heating oven. There the still active matrix materials of the contacted partially consolidated, gelled local regions are joined together and form a joint when they are hardened.

According to a preferred procedure, a heatable gap tool is employed which may or may not have a stitching head. This tool presses together the mutually applied partially consolidated, gelled local regions of two (or more) semifinished products, and heats them, thereby bringing the consolidation to an end (i.e. to a conclusion).

Also possible is the use of infrared heating or other contactless heating techniques, applied to the mutually applied partially consolidated, gelled local regions. The optional stitching head makes it possible to stitch the fiber reinforcing means of the semifinished composite-material products in the partially consolidated regions.

In all of the described methods of joining two or more component parts, local partially consolidated, gelled component part regions are crosslinked (fastened) together, but it is not necessary that they be completely consolidated. It may be necessary to achieve complete consolidation subsequently, by means of further processing according to the prior art, e.g. in a tempering oven.

In particular, the following procedure is preferred:

According to FIGS. 1A and 1B, gelled component part regions are at a degree of crosslinking which is beyond the gel point, in the direction of complete crosslinking, in a state in which the crosslinking reaction has been interrupted (degree of crosslinking less than 99%). Other component part regions are already substantially crosslinked, and are in a state (of a range) near 100% crosslinking. In order to join the component parts, it is necessary to re-activate the crosslinking reaction, such that it is possible to achieve a physical and/or chemical bonding which pervades the relevant parts of the component parts. Additionally, it is possible to stitch the partially consolidated, gelled component part regions prior to and during the crosslinking reaction, in order to achieve a joint which thoroughly involves the fibers, in addition to joining of the matrix system.

According to the invention, the crosslinking reaction is activated by at least one heatable tool which encompasses one or more partially consolidated, gelled component part regions. The tool is comprised of two or more elements which are heatable and/or include a cooling function. These elements are brought over one or more partially consolidated regions such that these regions are re-activated by the energy of the tool elements, and are crosslinked. The tool elements, in addition to providing a thermal influence on the partially consolidated regions, may also apply pressure to said regions. Depending on the fiber and matrix system, and the sizes of the partially consolidated, gelled regions, the joining procedures may involve stitching or stapling (with brief activation of the reaction, with the crosslinking proceeding independently of the tool), until crosslinking is carried out to completion in the tool. The structure of the tool may be generally that of a gap tool according to the prior art.

In order to achieve joining which involves the entire component part as regards the textile reinforcing means, in addition to the bonding of the matrix regions, additional process steps may be added to the above-described process. According to the invention, the consolidation process may be combined with a stitching process. The partially consolidated component parts may be immediately subjected to stitching (preferably after brief heating). The pattern of the stitching depends on the selected type and form of the textile reinforcing means. The stitching material is identical to the material of the textile reinforcing means of the component parts which are to be joined, or is compatible with that material and with the matrix system. Subsequently to this step, the consolidation is carried out further, with suitable process parameters.

The above-described tool is provided with a stitching head, according to the prior art.

FIG. 1A is a schematic diagram showing the isothermal hardening of a typical reactive resin system according to the prior art (e.g. an epoxy resin system) versus the hardening time (after Flemming, (in German) Fiber composite construction, ISBN 3-540-58645-8, p. 210). It indicates the course of the hardening (corresponding to the degree of crosslinking of the reactive resin system) over time, at constant hardening temperature. After a hardening time of 15 hr, the maximum static degree of crosslinking is reached, which is also described by the static glass transition temperature “Tg (static)”=129° C. The diagram shows in particular the gel point, i.e. gelling wherewith the resin system passes from a liquid state into an infusible solid state.

FIG. 1B is a schematic diagram showing the dependence of the morphological state of a typical reactive resin system according to the prior art (e.g. an epoxy resin system equivalent to FIG. 1B) on the degree of crosslinking and the temperature. In the diagram, the different morphological states are indicated (in regions between the lines of delimitation). In addition to the line of delimitation between evaporation and thermal decomposition, gelling is indicated at a degree of crosslinking of ca. 48%. Also indicated is the line of delimitation comprising the glass transition temperature (Tg) of the resin system at the given crosslinking state. The Tg for complete crosslinking is 129° C., which is also designated “Tg (static)” (static glass transition temperature). Tg (static) is also represented in the literature as “Tg∞” (Tg infinity).

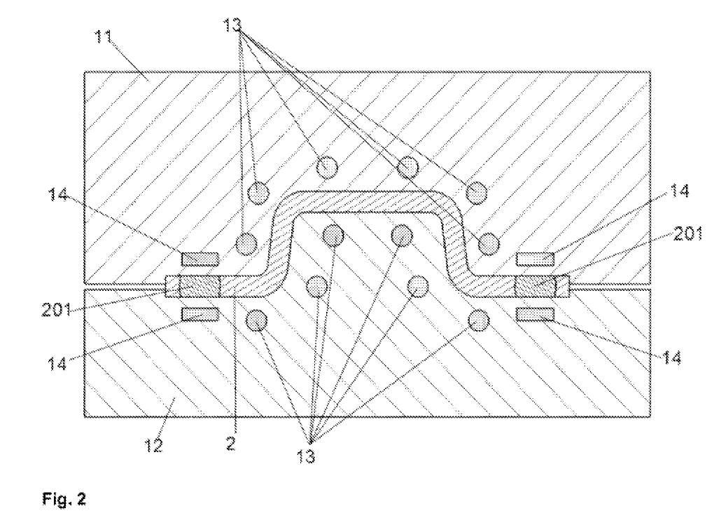

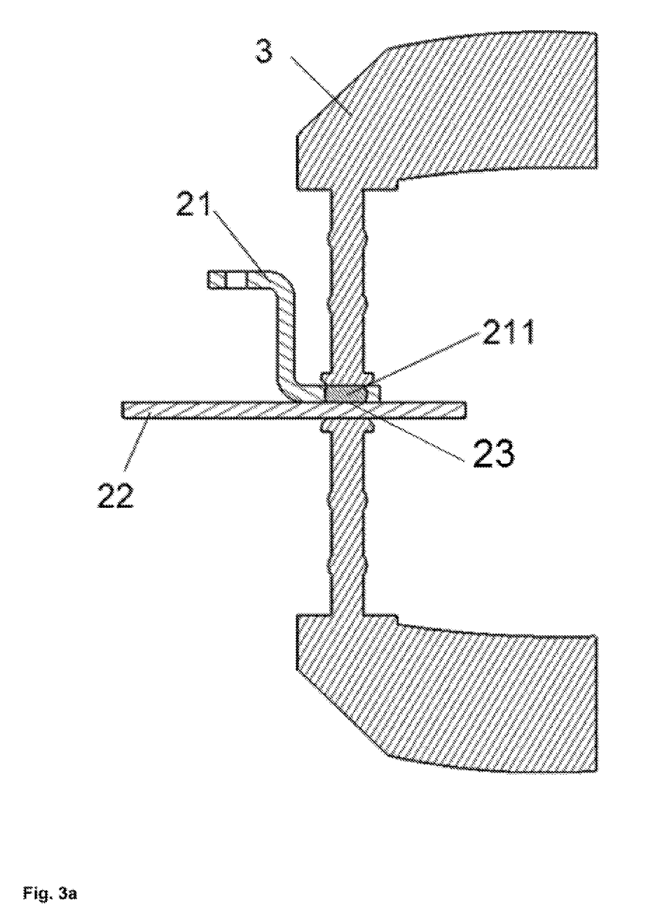

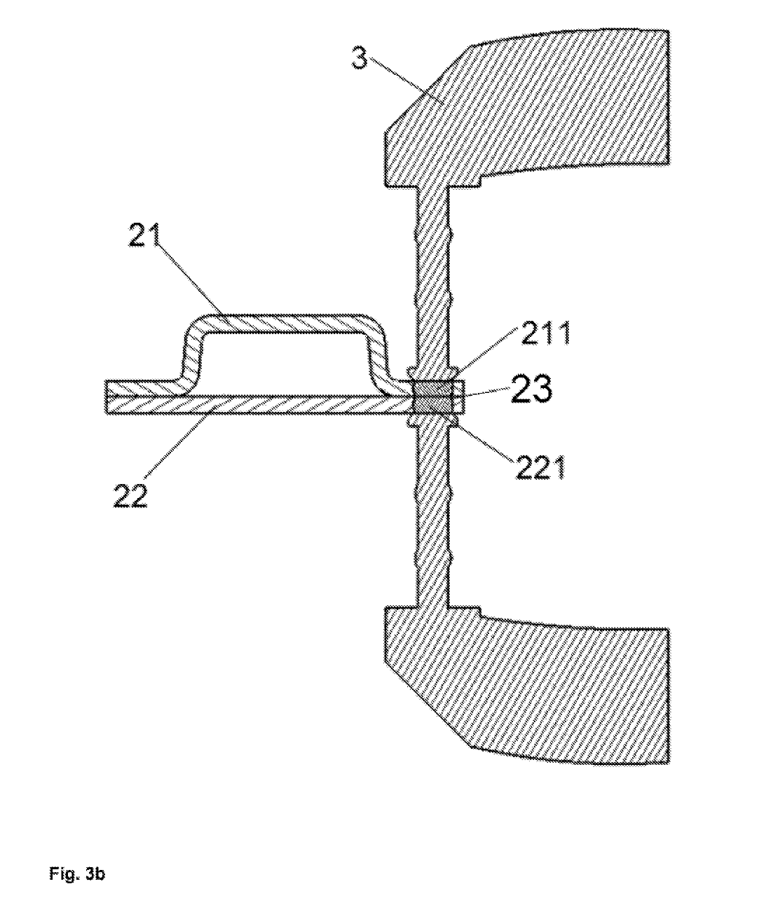

FIG. 2 shows the inventive tool during the execution of the inventive method. The two tool halves (11 and 12) enclose the fiber reinforcing material (2) impregnated with matrix material, and they re-form it. The heating elements (13) heat the lower tool part (12) and the upper tool part (11) over their entire surfaces (the surfaces of the tool parts), wherewith only local regions are defined by the cooling elements (14) in which regions the heating is reduced and the matrix material is partially consolidated (gelled). The joining between the two semifinished composite-material products (21, 22) according to FIGS. 3b and 4b is also shown.

FIG. 3a shows schematically the use of a gap tool (also called “joining tool”) in order to bond a completely consolidated semifinished product to a semifinished product which has a partially consolidated local region; and FIG. 3b shows the use of a gap tool to bond opposing partially consolidated, gelled local regiona.

FIGS. 4a and 4b show a curved hollow profile, in cross section (FIG. 4a) and in a perspective view (FIG. 4b), wherein the opposite edges of the semifinished product (21, 22) have been bonded by the inventive method.

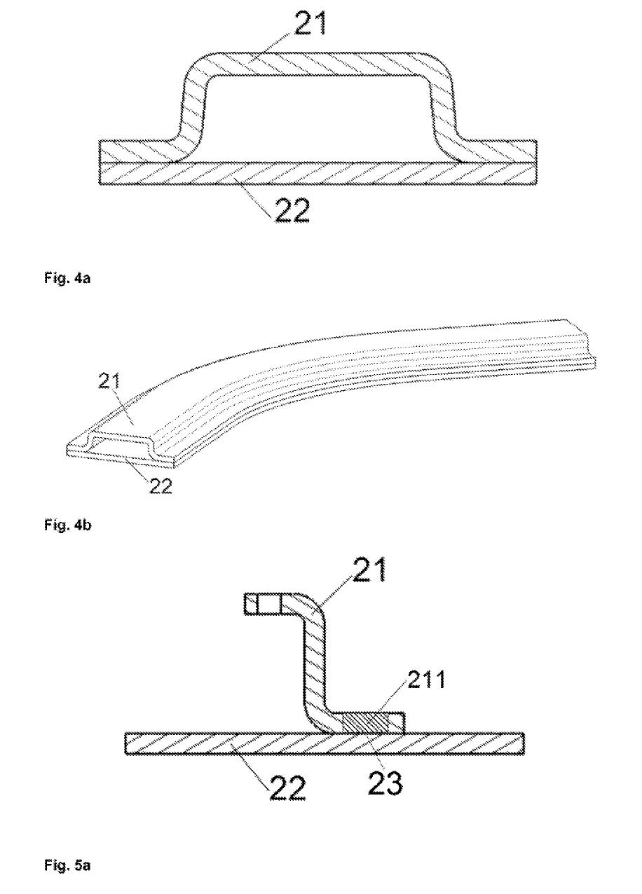

FIGS. 5a and 5b show schematically the application of a bonding element (21) to a flat element (22).

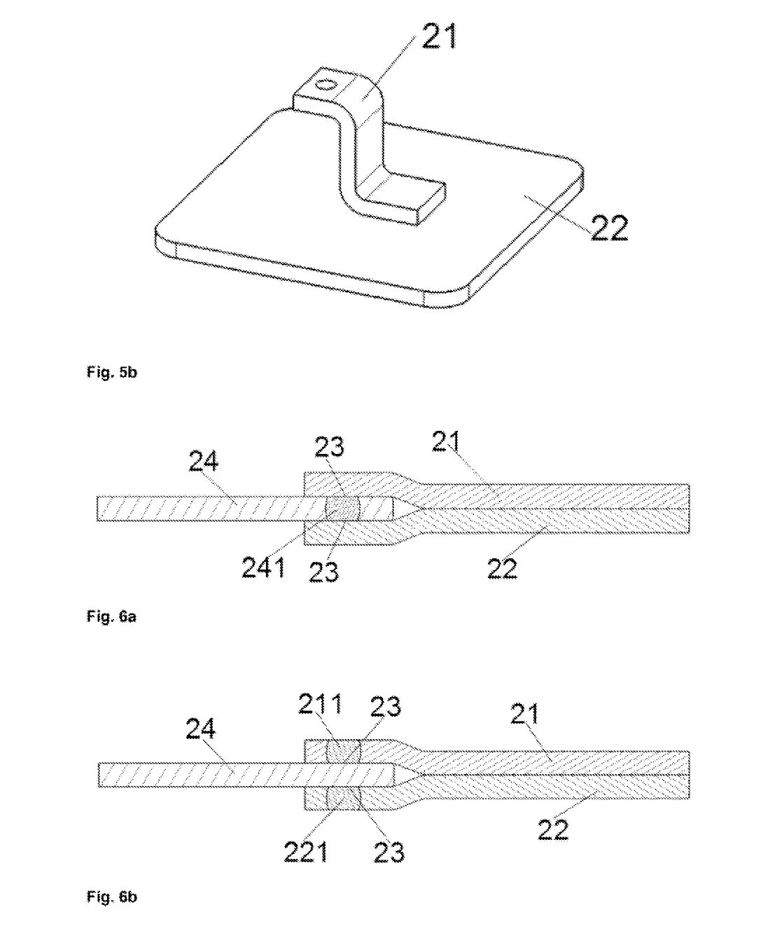

FIGS. 6a to 6c show schematically the realization of various double strap joints by means of partially consolidated, gelled gap regions on the flat element (24) and/or the straps (21, 22), according to the inventive method. In FIG. 6a, the flat element (24) has a partially consolidated region (241) which is bonded with the upper (21) and lower (22) straps at bonding locations (23), as hardening occurs. In FIG. 6b, the straps have partially consolidated, gelled regions (211, 221) which are bonded to the flat element (24) at the bonding locations (23). In FIG. 6c, each of the elements of the gap (21, 22, 24) has a partially consolidated, gelled region (211, 221, 241), wherewith the elements are bonded together with consolidation, at the bonding locations (23).

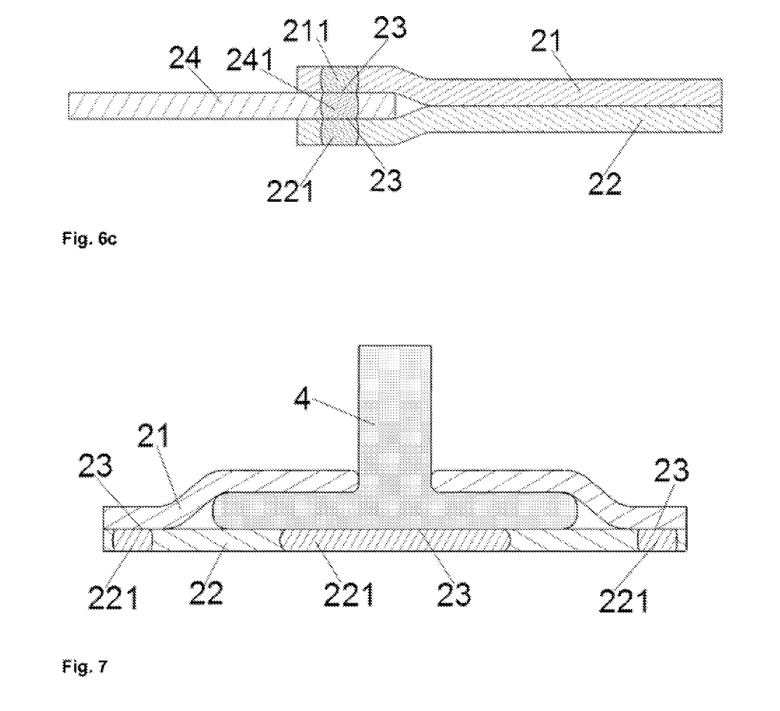

FIG. 7 shows schematically the integration of an insert (4) and its bonding to a component part (22) with partially consolidated, gelled gap regions (221), according to the inventive method. The insert (4) is disposed between a second component part (21) and the below-disposed component part (22). Bonding locations (23) are formed between the two component parts (21 and 22) and between the lower component part (22) and the insert (4).

The inventive method, accomplished in the inventive tool, is illustrated by the following exemplary embodiment. At the same time, the scope of the invention is not limited by the below-described steps and parameters.

### Step 1: Fabrication of a Semifinished Composite-Material Product Having Partially Consolidated Regions:

The description relates to fabrication of a plate-shaped component part comprised of 2 mm thick glass fiber reinforced epoxy resin with partially consolidated, gelled local regions. The epoxy resin system used gels at a degree of crosslinking of 48% (see FIGS. 1A and 1B) and has a glass transition temperature which depends on the degree of crosslinking, according to FIG. 1B.

First. 3 dry layers of fiberglass fabric with 220 g basis weight were inserted into an RTM infiltration tool, the tool was sealed to be air-tight, was heated to the infiltration temperature of 100° C., and was subjected to vacuum. (RTM=resin transfer molding.) The mixture of resin and hardener was heated to 100° C., and the infiltration was started. A holding pressure of 5 bar was used. After 10 min, the component part was completely infiltrated. The consolidation process was carried out, while continuing to maintain the holding pressure, according to the process variant described below, and then the tool temperature was reduced, the tool was opened, and the component part was removed from the mold. Following such removal, it is necessary to store the component part in a cool environment (depending on the particular process variant), so that the consolidation process is slowed very substantially (or nearly suspended).

To produce partially consolidated, gelled component part regions which later serve as bonding locations, the temperature in these regions was reduced during the consolidation, in order to slow the crosslinking reaction (or nearly suspend it) at these locations. This was accomplished by means of cooling elements (14) introduced into the RTM tool. FIG. 2 shows schematically a section of an RTM tool with the cooling elements (14) (which in the present instance were liquid-cooled channels).

### Process Variant 1A:

Following the infiltration, the component part was held 15 hr at 100° C., to accomplish consolidation. This achieved a nearly complete crosslinking of the resin system, with a degree of crosslinking of nearly 100%, according to FIGS. 1A and 1B.

However, at the bonding locations, the resin system was crosslinked only to an un-gelled state (40% degree of crosslinking), wherewith after ca. 3.5 hrs. consolidation time the cooling was begun, and thereby the crosslinking was interrupted. By means of the cooling elements, the bonding locations were cooled to ca. 10° C.

Following the consolidation time of 15 hr, the bonding locations in the component part were in a “prepreg” state, wherewith at the time of a later joining the bonding locations could be re-melted by heating. Accordingly, ca. 60% of the original monomers in the thermosetting crosslinking reaction were still available as “adhesive means” for the later joining.

### Process Variant 1B:

Following the infiltration, the component part was held 15 hr at 100° C. in the tool, for consolidation. A nearly complete crosslinking of the resin system was achieved, with a degree of crosslinking of nearly 100% (FIGS. 1 and 2).

At the bonding locations, the resin system was crosslinked up to a gelled state, with a degree of crosslinking of 60%, with cooling being started at ca. 4.5 hr consolidation time, resulting in subsequent interruption of the crosslinking. The effect of the cooling elements was to cool the bonding locations to ca. 10° C.

After the consolidation time of 15 hr, the bonding locations in the component part were at room temperature, in an un-meltable gelled solid state, so that when joining was attempted later, it was not possible to re-melt the bonding locations by heating. Only ca. 40% of the original monomers of the thermosetting crosslinking reaction were available for future joining; however, at the same time because of the un-meltability a possible soiling of the joining tools was avoided. At the time of the joining, the un-crosslinked monomers formed adhesive bonds beyond the borders of the component part, because they wetted the surfaces of the joining elements and adhesively bonded the latter.

### Process Variant 1C:

Following the infiltration, the component part was held 5 hr at 100° C. in the tool, for partial consolidation. The resin system of the entire component part was thereby brought only to a partially consolidated degree of crosslinking of 70%.

Thus only ca. 30% of the monomers were available for future joining; on the other hand, joining was possible at any location on the component part, and as a result of the gelled and substantially crosslinked state of the resin, the component part had excellent stability (e.g. in the event of handling processes).

### Step 2: Joining of Partially Consolidated Regions of Bonded Semifinished Products:

For the joining, the component part was disposed against a joining partner, so that the bonding location of the component part was located at the desired position of the joining partner. Then the respective bonding locations were subjected to pressure from a gap tool.

To activate the bonding location, it was heated to the specified process temperature, and adhesion was carried out, along with further consolidation. The heating was preferably by ultrasound waves, which were conducted through the gap tool to the bonding location, or otherwise by heatable welding heads according to the prior art.

To accomplish the joining, the region of the component part at the given bonding location was preferably heated to a temperature between the glass transition temperature corresponding to the given degree of crosslinking and Tg (static). For Process Variant 1A, this corresponds to a degree of crosslinking of 40% and a temperature range between ca. 20 and 129° C. (lower and upper temperature limits); for Process Variant 1B, this corresponds to a degree of crosslinking of 60% and a temperature range between ca. 40 and 129° C.; and for Process Variant 1C, this corresponds to a degree of crosslinking of 70% and a temperature range between ca. 50 and 129° C. To ensure reliable activation for the joining, preferably a brief starting period at 20° C. above the lowest temperature (thus 20° C. or 40° C. or 50° C.) was employed. With a higher heating temperature, the speed of the crosslinking at the bonding locations is increased. In order to increase the speed of the crosslinking reaction when performing joining, the upper temperature limit can be increased. However, the joining temperature should always be below the limiting temperature for thermal decomposition (and the evaporation temperature for the resin system) (see FIG. 2).

Also, the degree of crosslinking of the bonding location after the joining is determined by the holding time. Thus the degree of crosslinking of the resin system in the bonding location can be controlled via the holding time and the joining temperature. In an exemplary embodiment, the joining was carried out at 140° C. with holding time 1 hr, resulting in an increase in the degree of crosslinking in the bonding location of at least 10% (see FIG. 1).

Preferably, after the joining, the bonding location is brought to a temperature below the given glass transition temperature, while maintaining the pressing pressure. In this “glass” state (vitreous state), the resin system is inherently stable, so that the joints will remain effective after release of the pressing pressure (see FIG. 2).

If it is desired to bring about further crosslinking of the bonding locations and/or of the remainder of the component part following the joining, this can be accomplished by heating, and holding the joined component parts at a temperature below the given glass transition temperature. If the glass transition temperature is exceeded in the “subsequent crosslinking”, the bonding locations might not be damaged, but there is a risk of deformation of the pressed regions, which might lead to a negative effect on the load capacity.

Advantageously, the joining partners employed each comprise a component part having bonding locations according to the invention, so that during the joining there remains available additional “adhesive material” in the form of un-crosslinked monomer proportions, at the bonding locations.

Additional fabrication steps may be carried out between the fabrication of the semifinished product and the joining and/or the “subsequent crosslinking”.

### LIST OF REFERENCE NUMERALS

11 Upper tool half.
12 Lower tool half
13 Heating element.
14 Cooling element.
2 Semifinished composite-material product.
201 Partially consolidated local region of the semifinished composite-material product.
21 First semifinished composite-material product, for joining.
211 Partially consolidated local region of the first semifinished composite-material product.
22 Second semifinished composite-material product, for joining.
221 Partially consolidated local region of the second semifinished composite-material product.
23 Bonding location.
24 Third semifinished composite-material product, for joining.
241 Partially consolidated local region of the third semifinished composite-material product.
3 Joining tool.
4 Insert.

1. A component part comprised of fiber-reinforced composite material having a thermosetting crosslinking plastic matrix system; characterized in that local regions in the component part (said regions being designated “bonding locations” because they are designed for later joining with other component parts) have a gelled morphological state of the resin system.

2. The component part according to claim 1; characterized in that the partially consolidated region has a degree of crosslinking, α, between 1% and 99%, preferably between 2% and 90%.

3. The component part according to claim 1; characterized in that the partially consolidated region at room temperature is in a gelled and vitrified (glass-like) morphological state.

4. The component part according to claim 1; characterized in that the regions of the component part which are not designed for later joining with other component parts are nearly completely consolidated.

5. The component part according to claim 1; characterized in that the regions of the component part which are not designed for later joining with other component parts have the same degree of crosslinking as local regions of the component part which are designed for later joining with other component parts.

6. A device for fabrication of semifinished composite-material products from a fiber reinforcement means in textile form and a thermosetting thermally consolidatable matrix material, which device has a tool with at least two mold elements between which the textile fiber reinforcement is inserted, which textile has previously been impregnated with matrix material, or the device has channels for feeding the liquid matrix material; characterized in that the device further has heating elements for heating the mold elements, and has cooling elements for impeding or retarding the consolidation of the matrix material in sections of the textile fiber reinforcement at which in a gelled regions of the semifinished composite-material products are provided.

7. The device according to claim 6; characterized in that the cooling elements are in the form of channels for passage of a cooling liquid (cooling fluid), or in the form of electric Peltier elements.

8. The device according to claim 6; characterized in that the cooling or heating elements are attached to or mounted on the device from outside in order to achieve local temperature control of the matrix material, so as to at least partially impede consolidation in local regions.

9. The device according to claim 6; characterized in that the device has regions in which the heat capacity of the tool mold elements is changed so that cooled regions are produced.

10. A method for fabricating semifinished composite-material products; characterized in that semifinished products are fabricated from fiber reinforcing material and matrix material, wherewith the consolidation process of the entire semifinished product or of local regions of the product which are designed for later joining is maintained in a gelled morphological state.

11. The method according to claim 10; characterized in that the temperature in local regions of the semifinished composite-material products is changed, in order to obtain gelled regions.

12. The method according to claim 10 or 11; characterized in that the semifinished composite-material products are cut, pressed, temporarily stored, transported, or otherwise treated or handled, prior to further processing.

13. The method according to claim 12; characterized in that, during the described processes, the semifinished composite-material products are brought to a temperature which impedes or at least retards further consolidation of the gelled regions.

14. A method of fabricating thermosetting component parts from two or more semifinished composite-material products each of which semifinished products has a textile fiber reinforcing means and a matrix material; characterized in that that the two or more semifinished composite-material products at the gelled regions of at least one semifinished composite-material product are brought into contact in a manner such that the material of the gelled regions is bonded and the thus joined regions are subsequently completely consolidated.

15. The method according to claim 14; characterized in that the semifinished composite-material products are completely consolidated outside the regions which have been brought into surface contact.

16. The method according to claim 14; characterized in that the gelled regions of the semifinished composite-material products are brought into a generally flat surface contact.

17. The method according to claim 14-16; characterized in that the gelled regions of a plurality of semifinished composite-material products which are brought into contact are stitched, clamped, or stapled, or are fastened together by similar methods, before consolidation.

18. The method according to one of claims 14-17; characterized in that the gelled regions of a plurality of semifinished composite-material products which have been brought into contact are disposed such that they partially or completely surround inserts which are disposed between the said semifinished composite-material products.
